(19) United States
(12) Patent Application Publication
(10) Pub. No.: US 2008/0232118 A1
(43) Pub. Date: Sep. 25, 2008

(54) Street Light With Heat Dissipating Device

(76) Inventor: Jefferson Liu, Tamsui (TW)

Correspondence Address: LIN & ASSOCIATES INTELLECTUAL PROPERTY, INC., P.O. BOX 2339, SARATOGA, CA, 95070-0339, US

(21) Appl. No.: 12/048,205

(22) Filed: Mar. 13, 2008

(30) Foreign Application Priority Data
Mar. 19, 2007 (TW) 096204386

(51) Int. Cl. F21V 29/00

(52) U.S. Cl. 362/373

(57) ABSTRACT

A street light includes a post with a light unit connected thereto. The light unit defines an enclosed space therein, and a separation board located in the enclosed space to divide the enclosed space into a first space and a second space. The separation board includes a hole. A circuit board includes multiple light emitting members and is located in the first space and on the separation board. The light emitting members are received in the hole of the separation board. A heat dissipating device is located in the first space and secured on the circuit board. The heat dissipating device extends to outside of the light unit. The heat generated from the light emitting members is transferred to the heat dissipating device which transfers the heat to outside of the street light.

### BACKGROUND OF THE INVENTION

1. Field of the Invention

The present invention relates generally to a street light with a heat dissipating device, and more particularly, to a street light having a heat pipe which transfers heat from the street light to outside of the street light.

2. The Prior Arts

Light Emitting Diodes (LEDs) are widely used to replace traditional light bulbs because of energy-saving, long term of use and non-mercury. Whichever illuminated equipments generate heat during operation because of energy transferring and the heat makes the illuminated equipments to be operated in high temperature circumstance which reduces the lifetime of the illuminated equipments. It becomes a concern on how to reduce the heat during operation of the illuminated equipments.

A conventional street light does not equip with any heat dissipating device so that the heat cannot be dissipated out during operation. The conventional street light is not completely enclosed so that dust, rain drops or insects may enter into the street light to affect the illumination of the street light. As shown in FIG. 1, an improved street light is developed and includes an enclosed space defined by a top cover 11 and a lower cover 12. A separation board 14 is located in the enclosed space to define a first space 111 and a second space 121. The separation board 14 includes a hole 141 and a circuit board 15 is rested on the separation board 14 and seals the hole 141. A plurality of LEDs are mounted to the circuit board 15 and located in the second space 121. A heat conductive member 16 transfers the heat from the LEDs 13 to a plurality of fins 18 via the circuit board 15. A fan 17 is used to blow the heat away from the fins 18 via ventilation holes (not shown) in the top cover 11.

Due to a limited space of the street light, the number of the fins is restricted so that the heat can not be well dissipated out of the street light. Besides, each street light requires a fan which needs maintenance and the fan is located at high position so that the replacement becomes difficult and the fan is not easy to be checked whether it is out of order.

### SUMMARY OF THE INVENTION

A primary objective of the present invention is to provide a street light having a heat dissipating device, and the device effectively removes the heat from the street light to outside of the street light so as to reduce the temperature in the street light and improve the shortcomings of the conventional street lights.

The present invention provides a street light which comprises a post and a light unit connected to the post. The light unit includes an enclosed space defined by a top cover and a lower cover. A separation board is located in the enclosed space to define a first space and a second space. The first space is located between the top cover and the separation board, and the second space is located between the separation board and the lower cover. The separation board includes a hole. A circuit board includes a plurality of light emitting members and is located in the first space and is secured on the separation board so as to cover the hole. The light emitting members are received in the hole of the separation board. A heat dissipating device is located in the first space and on the circuit board. The heat dissipating device extends to outside of the light unit along the post. A positioning device positions the heat dissipating device to the circuit board.

The street light in accordance with the present invention provides a lower fabrication cost and maintenance fee, and the heat generated from the LEDs can be effectively dissipated out of the street light.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a partial cross sectional view of a conventional street light;

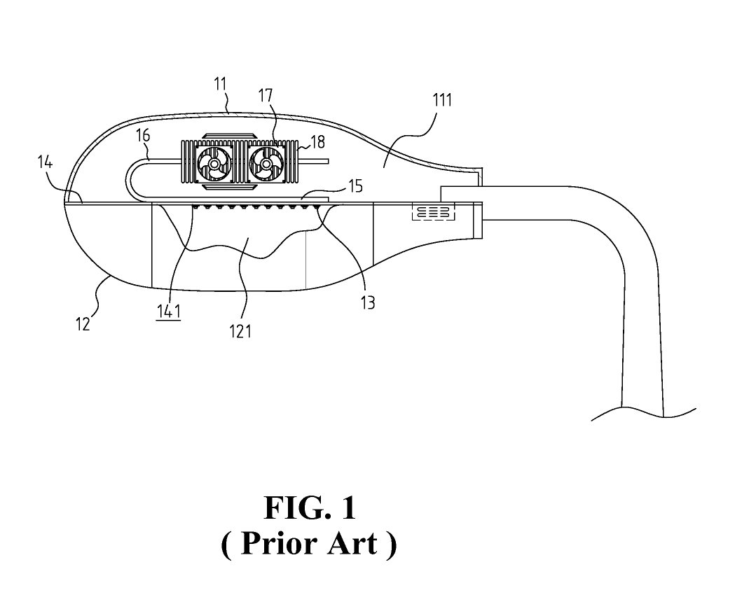

FIG. 2 is a perspective view of a street light of the present invention;

FIG. 3 is a partial cross sectional view of the street light of the present invention;

FIG. 4 shows a heat pipe is positioned between a circuit board and a positioning board according to a first embodiment of the present invention;

FIGS. 5A and 5B show another positioning of the heat pipe between the circuit board and the positioning board according to a second embodiment of the present invention; and

FIGS. 6A and 6B show that the heat pipe is engaged in the positioning board, and the positioning board is further mounted to the circuit board according to a third embodiment of the present invention.

### DETAILED DESCRIPTION OF THE PREFERRED EMBODIMENT

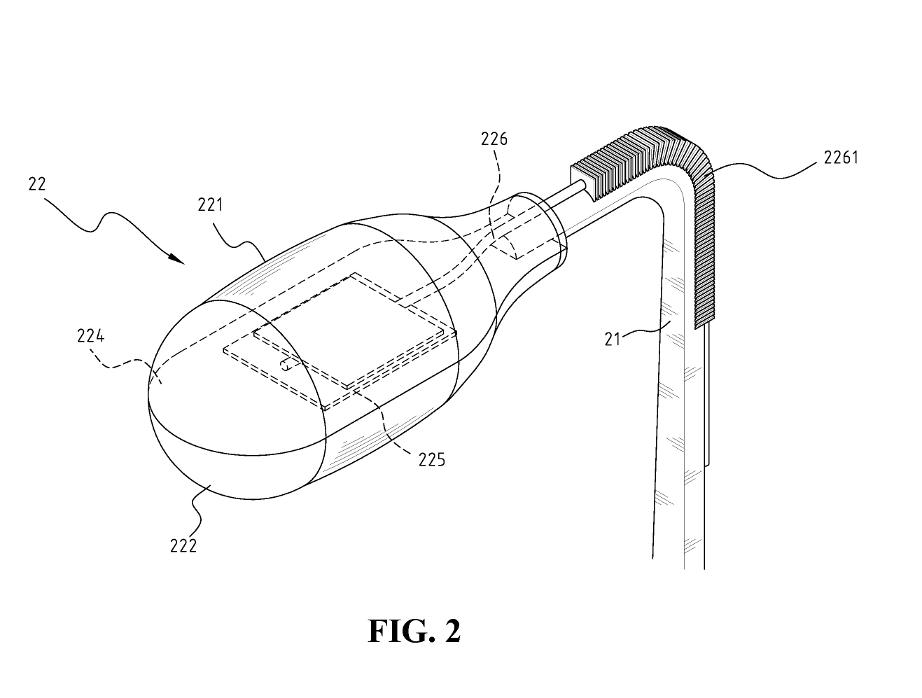

With reference to the drawings and in particular to FIG. 2, a street light in accordance with the present invention comprises an L-shaped post 21, a light unit 22 connected to the post 21 and including a top cover 221 and a lower cover 222 which are connected together to define an enclosed space.

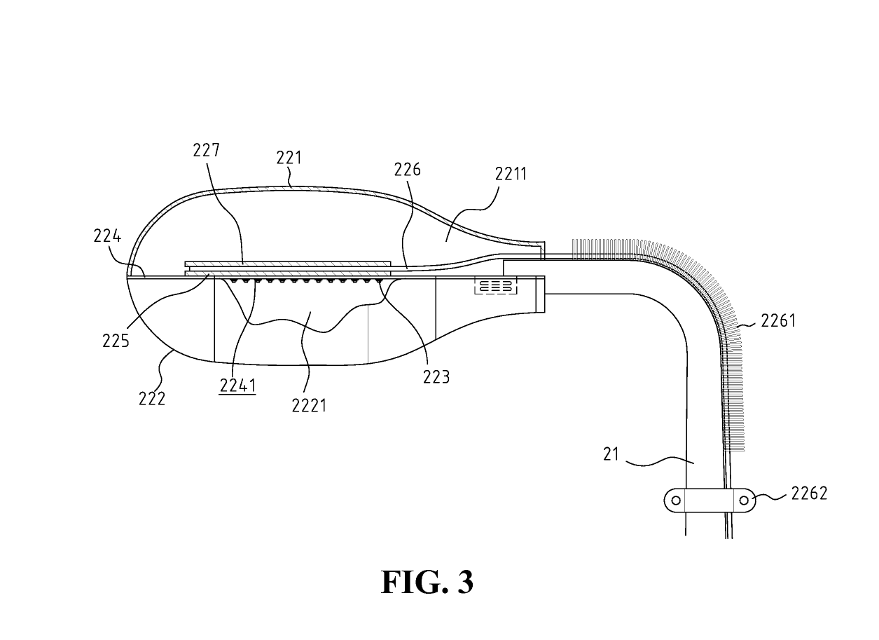

As shown in FIG. 3, the light unit 22 includes a separation board 224 located in the enclosed space, a circuit board 225 positioned on the separation board 224, a heat pipe 226 positioned on the circuit board 225 and a positioning board 227 for securing the heat pipe 226 on the circuit board 225.

The separation board 224 is located between the top and lower covers 221, 222 so as to divide the enclosed space of the light unit 22 into a first space 2211 and a second space 2221. The first space 2211 is located between the top cover 221 and the separation board 224 and the second space 2221 is located between the separation board 224 and the lower cover 222. The separation board 224 includes a hole 2241 which intercommunicates between the first space 2211 and the second space 2221.

The circuit board 225 includes a plurality of light emitting members such as Light Emitting Diodes 223 (LEDs) and is located on the separation board 224 in the second space 2221. The circuit board 225 covers the hole 2241 so as to prevent dust, rain drops and insects from entering the second space 2221. The Light Emitting Diodes 223 (LEDs) are received in the hole 2241 of the separation board 224. The LEDs 223 face the lower cover 222 and illuminate through the lower cover 222. The circuit board 225 is made by high heat conductive material so as to quickly transfer heat from the LEDs 223 to an area of lower temperature.

A heat dissipating device such as a heat pipe 226 is located in the first space 2211 and on the center of the circuit board 225. The heat pipe 226 extends through the top cover 221 and along the post 21 outside of the light unit 22. The heat pipe 226 is in contact with the circuit board 225 which carries the high temperature so that the heat can be dissipated out of the light unit 22 and cooled by the air of lower temperature. By this way, the temperature of the LEDs 223 is reduced. Besides, the heat pipe 226 includes a plurality of fins 2261 connected thereto so as to provide a larger contact area with the air to quickly dissipate heat to the air. In this embodiment, the heat pipe 226 is installed along the post 21 and can be installed to the outside or inside of the post 21. A mounting member 2262 is used to securely mount the heat pipe 226 to the post 21. The mounting member 2262 can be any known means such as screws or clips. The mounting member 2262 may be multiple ones. The position of the heat pipe 226 located on the circuit board 225 may be adjusted according to the requirement.

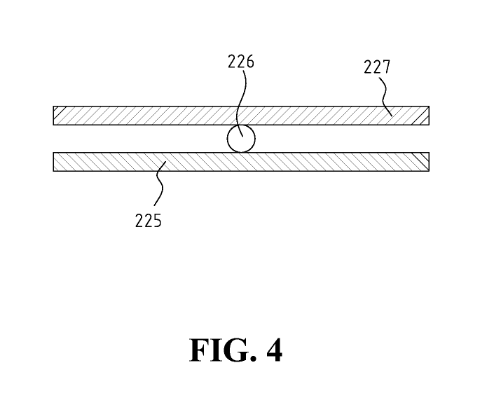

As shown in FIG. 4, the positioning board 227 is a rectangular board which positions the heat pipe 226 between the positioning board 227 and the circuit board 225 by way of screws, rivets, welding, casting or force-fitting. The heat pipe 226 may be either a single one or multiple ones. The diameter and/or length of the heat pipe 226 may also be increased to obtain the better heat dissipating effect.

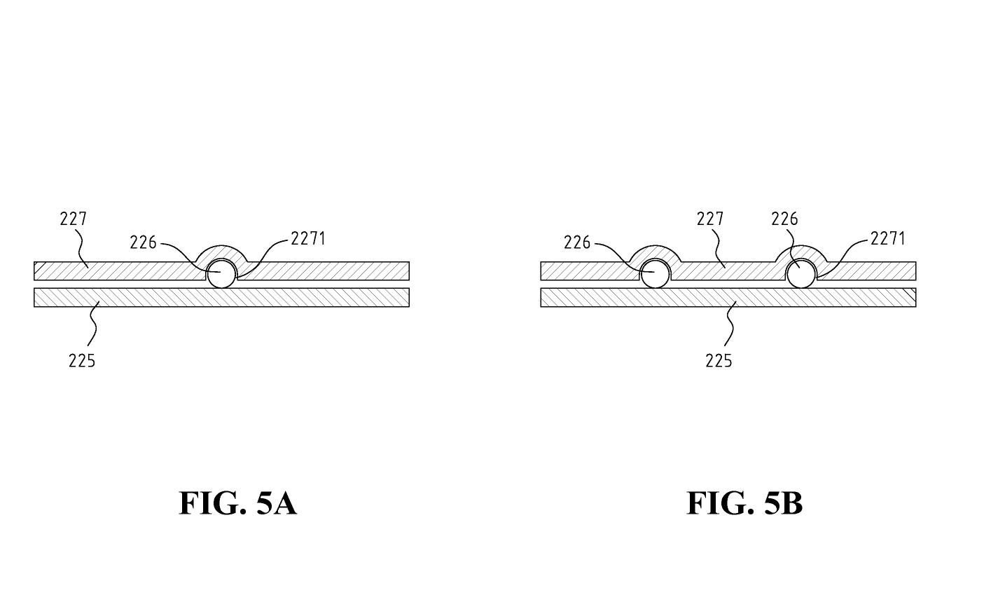

As shown in FIG. 5A, the positioning board 227 includes a groove 2271 in which the heat pipe 226 is engaged. Again, referring to FIG. 5B, the positioning board 227 includes two grooves 2271 for engaging two heat pipes 226 thereto, respectively.

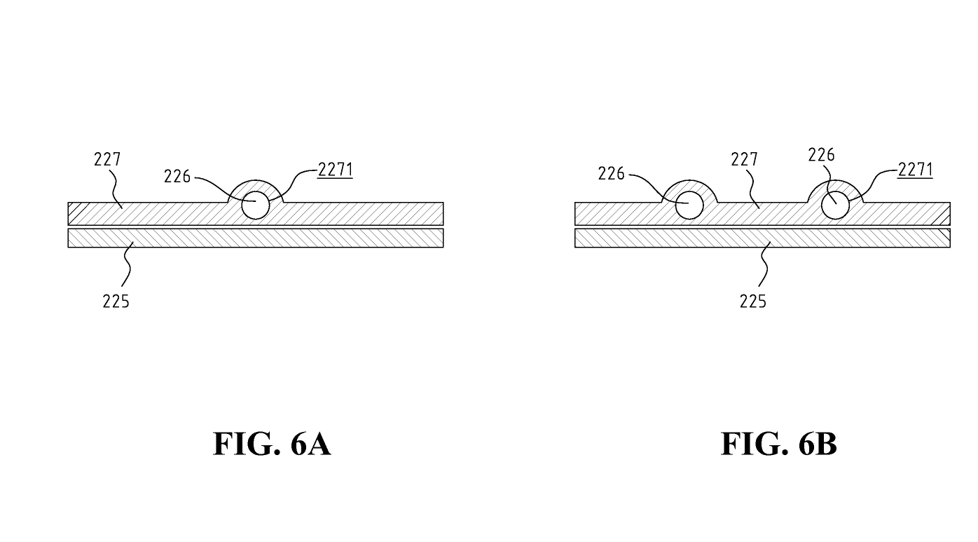

As shown in FIG. 6A, the positioning board 227 has a pre-set groove 2271 and the heat pipe 226 is completely received therein. Again, referring to FIG. 6B, the positioning board 227 includes two grooves 2271, and two heat pipes 226 are engaged therein, respectively. The grooves 2271 may be circular grooves, semi-circular grooves or any other shaped grooves for engaging the heat pipes 226 therein.

Referring to FIG. 3, when the LEDs 223 are operated and heat is generated, the heat is absorbed by the circuit board 225 and transferred to the heat pipe 226 which transfers the heat to outside of the light unit 22 and further to the air via the fins 2261.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A street light, comprising
a post;
a light unit connected to the post and including a top cover and a lower cover which are connected together to define an enclosed space, a separation board located in the enclosed space to define a first space and a second space, in which the first space is located between the top cover and the separation board and the second space is located between the separation board and the lower cover, the separation board including a hole;
a circuit board including a plurality of light emitting members and located in the first space and secured on the separation board, the light emitting members received in the hole of the separation board;
a heat dissipating device located in the first space and on the circuit board, the heat dissipating member extending to outside of the light unit; and
a positioning device positioning the heat dissipating device to the circuit board.

2. The street light as claimed in claim 1, wherein the heat dissipating device is a heat pipe.

3. The street light as claimed in claim 1, wherein the light emitting members are Light Emitting Diodes.

4. The street light as claimed in claim 2, wherein the heat pipe extends along the post and at least one mounting member secures the heat pipe on the post.

5. The street light as claimed in claim 2, wherein the heat pipe includes a plurality of fins connected thereto.

6. The street light as claimed in claim 5, wherein the heat pipe extends along the post and at least one mounting member secures the heat pipe on the post.

7. The street light as claimed in claim 4, wherein the heat pipe is connected to an outside or an inside of the post.

8. The street light as claimed in claim 6, wherein the heat pipe is connected to an outside or an inside of the post.

9. The street light as claimed in claim 4, wherein the heat pipe is a single one or multiple ones.

10. The street light as claimed in claim 6, wherein the heat pipe is a single one or multiple ones.
